(19) United States
(12) Patent Application Publication
(10) Pub. No.: US 2026/0346624 A1
(43) Pub. Date: Nov. 5, 2026

(54) PRINTING APPARATUS, METHOD, AND STORAGE MEDIUM STORING PROGRAM

(71) Applicant: CANON KABUSHIKI KAISHA, Tokyo (JP)

(72) Inventor: TAKASHI SAWADA, Saitama (JP)

(21) Appl. No.: 19/550,869

(22) Filed: Feb. 26, 2026

(30) Foreign Application Priority Data
Mar. 3, 2025 (JP) 2025-033161

(51) Int. Cl. B41J 13/00; B41J 13/10; G06F 3/12

(52) U.S. Cl. CPC B41J 13/0018; B41J 13/103; G06F 3/1204; G06F 3/1215; G06F 3/124; G06F 3/1252; G06F 3/1254

(57) ABSTRACT

A printing apparatus, in a case in which a first sheet type set for a first sheet-feeding unit and a second sheet type set for a second sheet-feeding unit that houses sheets of a same size as sheets housed in the first sheet-feeding unit are different from one another, determines whether image generation corresponding to the first sheet type or image generation corresponding to the second sheet type is to be performed, based on a combination of the first sheet type and the second sheet type, and perform the image generation corresponding to the determined sheet type; and, after the image generation, execute printing using the first sheet-feeding unit as a sheet-feeding source, and, based on the combination, controls whether or not the sheet-feeding source is to be switched from the first sheet-feeding unit to the second sheet-feeding unit when the sheets in the first sheet-feeding unit are exhausted.

### BACKGROUND

### Field of the Technology

The present disclosure relates to a printing apparatus, a method, and a storage medium storing a program that are capable of switching between sheet-feeding units.

### Description of the Related Art

Japanese Patent Laid-Open No. 2009-187036 discloses the technique of controlling, based on print mode, a sheet cassette changing function of continuing the supply of sheets by switching to another sheet cassette having sheets of the same size stacked thereon. Furthermore, there are known inkjet-printer techniques of changing the color tone for printing or changing the ink application amount depending on the type of sheet on which printing is performed.

### SUMMARY

The present disclosure provides a printing apparatus, a method, and a storage medium storing a program that suppress a decrease in print processing efficiency and a decrease in print quality that are otherwise caused by switching between sheet-feeding units during printing.

The present disclosure in one aspect provides a printing apparatus comprising at least one memory and at least one processor which function as: an image generation unit configured to, in a case in which a first sheet type set for a first sheet-feeding unit and a second sheet type set for a second sheet-feeding unit that houses sheets of a same size as sheets housed in the first sheet-feeding unit are different from one another, determine whether image generation corresponding to the first sheet type or image generation corresponding to the second sheet type is to be performed, based on a combination of the first sheet type and the second sheet type, and perform the image generation corresponding to the determined sheet type; and a print control unit configured to, after the image generation is performed by the image generation unit, execute printing using the first sheet-feeding unit as a sheet-feeding source, and, based on the combination, control whether or not the sheet-feeding source is to be switched from the first sheet-feeding unit to the second sheet-feeding unit when the sheets in the first sheet-feeding unit are exhausted.

According to the present disclosure, a decrease in print processing efficiency and a decrease in print quality that are otherwise caused by switching between sheet-feeding units during printing can be suppressed.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of an internal configuration of a printing apparatus.

FIG. 2 is a block diagram illustrating a control configuration of the printing apparatus.

FIG. 3 is a flowchart illustrating processing by the printing apparatus.

FIG. 4 is a diagram for describing execution of image generation processing and print control processing.

FIG. 5 is a diagram illustrating setting parameters corresponding to sheet types.

FIG. 6 is a flowchart illustrating processing by the printing apparatus.

FIG. 7 is a flowchart illustrating processing by the printing apparatus.

FIG. 8 is a diagram illustrating a table for specifying ranks.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In a case in which printing is to be performed on a different sheet type due to switching between sheet-feeding cassettes being performed during printing, the print processing efficiency would decrease if an image is newly generated after the switching between sheet-feeding units, such as sheet-feeding cassettes. Furthermore, the print result may differ from what is intended by the user.

According to the present disclosure, a decrease in print processing efficiency and a decrease in print quality that are otherwise caused by switching between sheet-feeding units during printing can be suppressed.

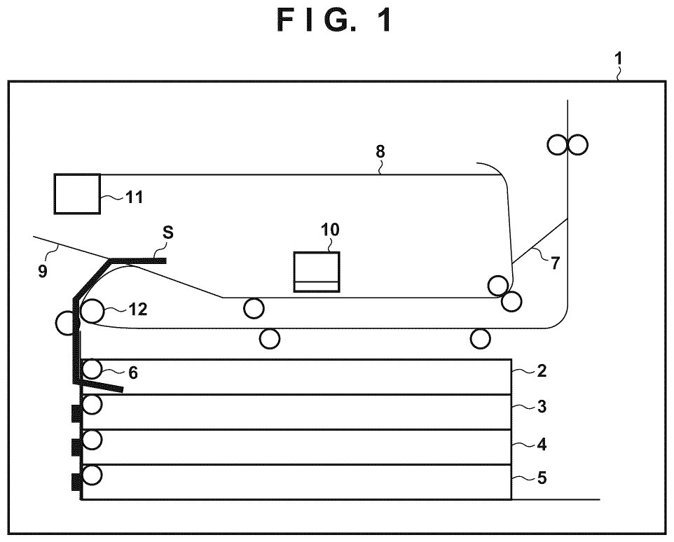

FIG. 1 is a diagram illustrating an example of an internal configuration of an inkjet printing apparatus 1 (hereinafter “printing apparatus 1”) that will be referred to in the present embodiment. The printing apparatus 1 is an apparatus including a printing unit; however, the printing apparatus 1 may be implemented so as to have functions as a multifunction peripheral including a scanner unit. Furthermore, the printing apparatus 1 has a configuration including four sheet-feeding cassettes that are in a vertical positional relationship relative to one another, as will be described in the following; however, the number of sheet-feeding cassettes need not be four, and may be one, or five or more. Note that the left side in the drawing corresponds to the front (front surface) of the printing apparatus 1, and the user can draw out each sheet-feeding cassette toward the left side in the drawing, i.e., toward the user side.

A configuration is adopted such that sheet-feeding cassette 2 is the uppermost sheet-feeding cassette, sheet-feeding cassette 3 is positioned below the sheet-feeding cassette 2, sheet-feeding cassette 4 is positioned further therebelow, and sheet-feeding cassette 5 is positioned lowermost. Sheet-feeding cassettes 2 to 5 are each configured such that a housing portion that houses a printing medium such as sheets can be slid and drawn out from the housing of the printing apparatus 1. Hereinafter, unless otherwise indicated, description will be provided taking sheet-feeding cassette 2 as a representative example of sheet-feeding cassettes 2 to 5.

Inside the printing apparatus 1, a sheet-feeding roller 6 and conveyance rollers 12 are configured to convey a sheet through a conveyance path from the supply of the sheet from sheet-feeding cassette 2 to the discharge of the sheet, and the sheet-feeding roller 6 is used to pick up sheets stacked in sheet-feeding cassette 2. A printing head 10 is a printing unit that performs printing on sheets by ejecting ink droplets from nozzle rows corresponding to the colors that can be printed by the printing apparatus 1. The printing head 10 may be a so-called serial printing head that can reciprocate in a direction orthogonal to the sheet conveyance direction, or a so-called line printing head that is formed to extend across the sheet width direction.

For example, when sheet-feeding cassette 2 is selected and printing is started in a state in which sheets are housed in sheet-feeding cassette 2, a sheet S is picked up by the sheet-feeding roller 6 attached to sheet-feeding cassette 2 to be supplied to the conveyance path. The sheet S supplied to the conveyance path is conveyed through the conveyance path, and is subjected to printing based on printing data by the printing head 10. In the case of single-sided printing, the sheet S having been subjected to printing is conveyed through a sheet discharge path 8 and is discharged in a state in which the surface on which printing has been performed is facing downward (face-down). On the other hand, in the case of double-sided printing, the sheet S having been subjected to printing is conveyed through a double-sided printing path via a reversing path 7, and printing based on printing data is performed again by the printing head 10 on the back surface thereof. Then, the sheet S is conveyed through the sheet discharge path 8 to be discharged.

The printing apparatus 1 may have formed therein one or more trays, other than sheet-feeding cassettes 2 to 5, that are capable of supplying sheets to the conveyance path. For example, a type of printing medium desired by the user can be set on a manual feed tray 9, and the printing medium can be supplied to the conveyance path. Note that, in the present embodiment, the manual feed tray 9 is positioned so that the user can manually set a printing medium on the manual feed tray 9 from the front side of the printing apparatus 1. However, there is no limitation to such a form, and, for example, the manual feed tray 9 may be positioned so that the user can manually set a printing medium on the manual feed tray 9 from the back side (opposite side from the front side) of the printing apparatus 1. An operation panel 11 is configured to be capable of receiving input/output operations performed on the printing apparatus 1 by the user. Via the operation panel 11, the user can provide instructions for operations such as copying and scanning, and set a print mode. Furthermore, the operation panel 11 functions as a display unit that displays pieces of information relating to the printing apparatus 1. The operation panel 11 may include hardware keys, or may be configured as a touch panel.

The printing apparatus 1 in the present embodiment is a front-surface-conveyance-type printing apparatus; however, the printing apparatus 1 may have a different conveyance path formed therein.

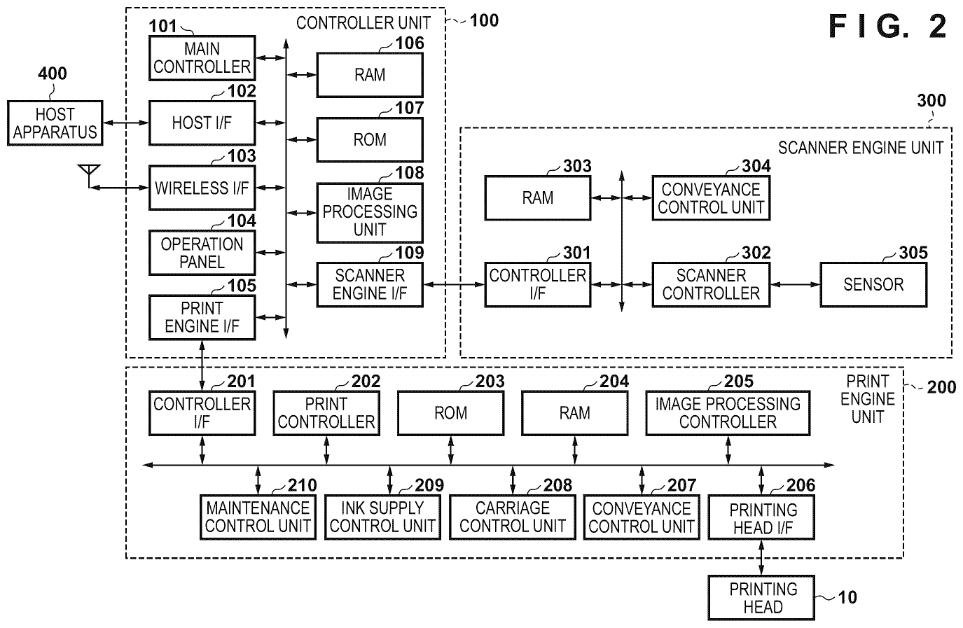

FIG. 2 is a block diagram illustrating a control configuration of the printing apparatus 1. The control configuration is configured to include a print engine unit 200 that mainly controls printing operations, a scanner engine unit 300 that controls scanning operations, and a controller unit 100 that controls the entire printing apparatus 1. A print controller 202 controls various mechanisms of the print engine unit 200 in accordance with instructions from a main controller 101 of the controller unit 100. Various mechanisms of the scanner engine unit 300 are controlled by the main controller 101 of the controller unit 100. The control configuration will be described in detail in the following.

In the controller unit 100, the main controller 101, which is configured to include a CPU, controls the entire printing apparatus 1 in accordance with one or more programs and various parameters stored in a ROM 107 while using a RAM 106 as a work area. For example, when a print job is input via a network from an external host apparatus 400, which is a PC or the like, through a host I/F 102 or a wireless I/F 103, an image processing unit 108 executes predetermined image processing on received image data in accordance with an instruction from the main controller 101. Then, the main controller 101 transmits the image data having been subjected to the image processing to the print engine unit 200 via a print engine I/F 105.

Note that the printing apparatus 1 may obtain image data from the host apparatus 400 via wireless communication or wired communication, or may obtain image data from an external storage device (USB memory or the like) connected to the printing apparatus 1. The communication methods used for the wireless communication and the wired communication are not particularly limited. For example, Wireless Fidelity (Wi-Fi) (registered trademark) or Bluetooth (registered trademark) may be adopted as the communication method used for wireless communication. Furthermore, Universal Serial Bus (USB) or the like is applicable as the communication method used for wired communication. In addition, when a read command is input from the host apparatus 400, the main controller 101 transmits the read command to the scanner engine unit 300 via a scanner engine I/F 109.

An operation panel 104 is a mechanism for receiving input/output from the user to the printing apparatus 1, and corresponds to the operation panel 11 in FIG. 1. Examples of input/output operations from the user include those for providing operation instructions for copying, scanning, etc., and those for setting print modes including color printing, monochrome printing, etc., both of which are provided via the operation panel 104. Furthermore, the operation panel 104 can display various user interface screens.

In the print engine unit 200, the print controller 202, which is configured to include a CPU, controls various mechanisms of the print engine unit 200 in accordance with one or more programs and various parameters stored in a ROM 203 while using a RAM 204 as a work area. Upon receiving various commands and image data via a controller I/F 201, the print controller 202 temporarily stores the received commands and image data in the RAM 204. So that the printing head 10 can perform printing operations, the print controller 202 controls an image processing controller 205 so as to convert the stored image data into printing data. When printing data is generated as a result of the conversion, the print controller 202 causes the printing head 10 to execute printing operations via a printing head I/F 206. In doing so, the print controller 202, via a conveyance control unit 207, drives the conveyance rollers 12 and the sheet-feeding roller 6 to convey a printing medium S. Print processing is executed by recording operations being executed by the printing head 10 in accordance with instructions from the print controller 202 and in conjunction with operations for conveying the printing medium S.

A carriage control unit 208 changes the orientation and position of the printing head 10 in accordance with the operation state of the printing apparatus 1, such as a maintenance state or a printing state. An ink supply control unit 209 controls an ink supply unit (not illustrated) so that the pressure of ink supplied to the printing head 10 is within an appropriate range. A maintenance control unit 210 controls operations of a cap unit (not illustrated) and a wiping unit (not illustrated) when maintenance operations are performed on the printing head 10.

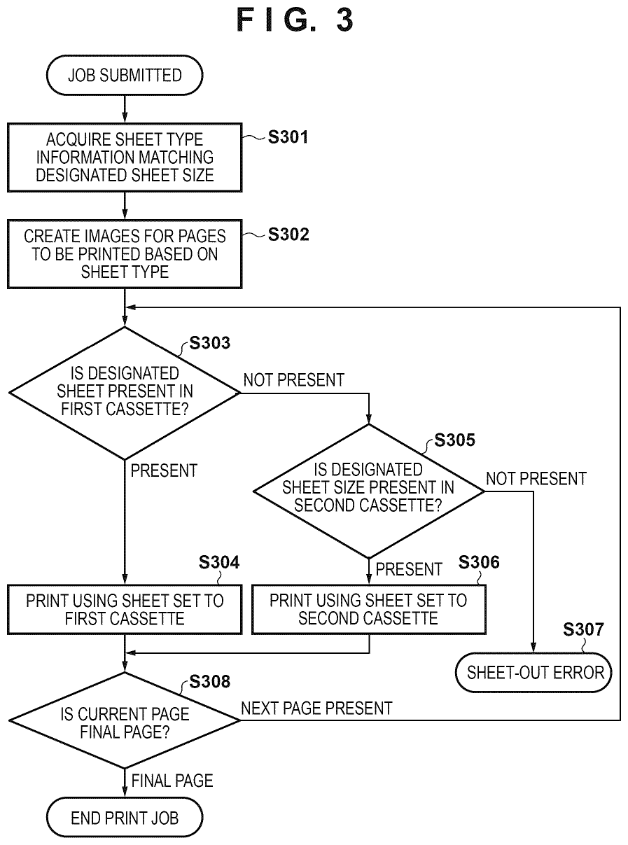

In regard to the scanner engine unit 300, the main controller 101 controls hardware resources of a scanner controller 302 in accordance with one or more programs and various parameters stored in the ROM 107 while using the RAM 106 as a work area. Thus, various mechanisms included in the scanner engine unit 300 are controlled. For example, the main controller 101 controls the hardware resources in the scanner controller 302 via a controller I/F 301. Accordingly, a document placed on an automatic document feeder (ADF) by the user is conveyed by means of a conveyance control unit 304 and is read by a sensor 305. Then, the scanner controller 302 stores, in a RAM 303, image data that is generated as a result of the document being read. Note that, by converting the image data acquired as described above into printing data, the print controller 202 can cause the printing head 10 to execute printing operations based on the image data read by the scanner controller 302. The printing apparatus 1 is not limited to having the configurations illustrated in FIGS. 1 and 2, and may include, as appropriate, functional blocks that can be executed by the device used as the printing apparatus 1. FIG. 3 is a flowchart illustrating processing executed when a print job is submitted to the printing apparatus 1. For example, the processing in FIG. 3 is realized by the main controller 101 loading and executing one or more programs stored in the ROM 107 in the RAM 106. In the present embodiment, a case will be described in which the print job includes data for a plurality of pages. When the print job is processed, image generation processing for generating an image and print control processing for forming a generated image onto a sheet are executed in parallel to increase print job processing speed. For example, the processing in FIG. 3 is started when the user provides an instruction for executing copying or printing on a user interface screen displayed on the operation panel 104.

In step S301, the main controller 101 acquires the sheet size designated by the print job. The sheet size is designated by the user upon submission of the print job. The main controller 101 checks whether the designated sheet size is set to sheet-feeding cassette 2 located at the top level. If the sheet size is not set to sheet-feeding cassette 2 located at the top level, the main controller 101 checks if the sheet size is set to another sheet-feeding cassette, e.g., sheet-feeding cassette 3 located at the second level. The main controller 101 acquires sheet type information set to the sheet-feeding cassette with the matching sheet size.

In the present embodiment, the main controller 101 checks the sheet-feeding cassettes in order starting from the sheet-feeding cassettes located at higher levels. For example, in the configuration in FIG. 1, the sheet-feeding cassettes are checked in the order of sheet-feeding cassette 2, sheet-feeding cassette 3, sheet-feeding cassette 4, and sheet-feeding cassette 5. A configuration may be adopted such that the order in which the sheet-feeding cassettes are to be checked can be set in advance by the user via the operation panel 104. In the present embodiment, it is assumed that the order is set in advance to the order of sheet-feeding cassette 2, sheet-feeding cassette 3, sheet-feeding cassette 4, and sheet-feeding cassette 5. In the following, the order in which the sheet-feeding cassettes are to be checked is referred to as the priority ranks of the sheet-feeding cassettes.

In step S302, based on the sheet type information acquired in step S301, the main controller 101 executes image generation processing by means of the image processing unit 108.

Generally, the ink application amount, the ink to be used in accordance with the print mode, etc., when an image is to be formed onto a sheet vary for each sheet type. There are cases in which the user does not designate the desired sheet type or sheet-feeding cassette, and a setting is made such that a sheet type and sheet-feeding cassette are to be automatically selected. In such a case, the print result may differ significantly from the print quality desired by the user. On the other hand, there are cases in which the absence of sheets in a sheet-feeding cassette is detected, and switching is performed to another sheet-feeding cassette corresponding to the same sheet size. In such a case, the throughput of processing of the print job would decrease if an image is newly generated based on the sheet type set to the other sheet-feeding cassette (image generation processing) and the generated image is then formed on a sheet (print control processing). Furthermore, the print result may differ significantly from the print quality desired by the user due to print quality, such as color tone, changing when switching between sheet-feeding cassettes occurs.

According to the present embodiment, the most-suitable sheet type among sheet types set to a plurality of sheet-feeding cassettes corresponding to the same sheet size is determined, and image generation processing is executed based on the most-suitable sheet type. Furthermore, image generation processing and print control processing are executed by separate controllers within the printing apparatus 1. Thus, a situation in which the print result significantly differs from the print quality desired by the user can be prevented, and a decrease in throughput of processing of a print job can be prevented. Note that, while description is provided in the present embodiment with reference to a form in which switching is performed among sheet-feeding cassettes 2 to 5 for example, the manual feed tray 9 may be further included among the sheet-feeding units among which switching is performed.

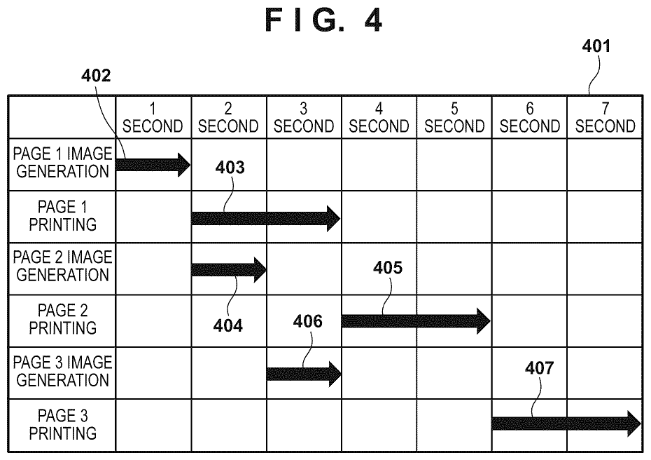

The image generation processing in step S302 will be described with reference to FIGS. 4 to 8. At the point when the processing in step S302 ends, images for the plurality of pages included in the print job have been formed. Here, suppose that the sheet size designated by the print job is set to sheet-feeding cassettes 2 and 3 in step S301.

In step S303, the main controller 101 focuses on one page, and determines whether or not a sheet is present in the sheet-feeding cassettes to which the sheet size designated by the print job is set. Here, for example, it is supposed that the sheet-feeding cassettes to which the sheet size designated by the print job is set are sheet-feeding cassettes 2 and 3. That is, as one example, the main controller 101 determines whether or not a sheet is present in sheet-feeding cassettes 2 and 3. The order in which the processing for determining the presence/absence of a sheet in sheet-feeding cassettes 2 and 3 is executed follows the above-described priority ranks of the sheet-feeding cassettes.

If it is determined that a sheet is present in sheet-feeding cassette 2, the print engine unit 200 forms an image on a sheet fed from sheet-feeding cassette 2 in step S304.

On the other hand, if it is determined that no sheet is present in sheet-feeding cassette 2, in step S305, the main controller 101 determines whether or not a sheet is present in the next sheet-feeding cassette based on the priority ranks. Here, the main controller 101 determines whether or not a sheet is present in sheet-feeding cassette 3.

If it is determined that a sheet is present in sheet-feeding cassette 3, the print engine unit 200 forms an image on a sheet fed from sheet-feeding cassette 3 in step S306. A configuration may be adopted such that, if it is determined that a sheet is present in sheet-feeding cassette 3, a screen for providing a notification that switching between sheet-feeding cassettes will be performed is displayed before advancing to step S306. Furthermore, a configuration may be adopted such that an instruction to switch or an instruction not to switch can be received on the screen. In such a case, a configuration may be adopted such that processing advances to step S306 if an instruction to switch is received.

On the other hand, if it is determined that no sheet is present in sheet-feeding cassette 3, the main controller 101 determines that a sheet-out error has occurred and executes error processing in step S307. For example, the error processing is processing for displaying, on the operation panel 104, a screen for providing a notification of the sheet-out error.

In step S308, the main controller 101 determines whether or not the current page is the final page among the plurality of pages included in the print job. If it is determined here that the current page is not the final page, the processing from step S303 is repeated focusing on the next page. On the other hand, if it is determined that the current page is the final page, the processing in FIG. 3 ends.

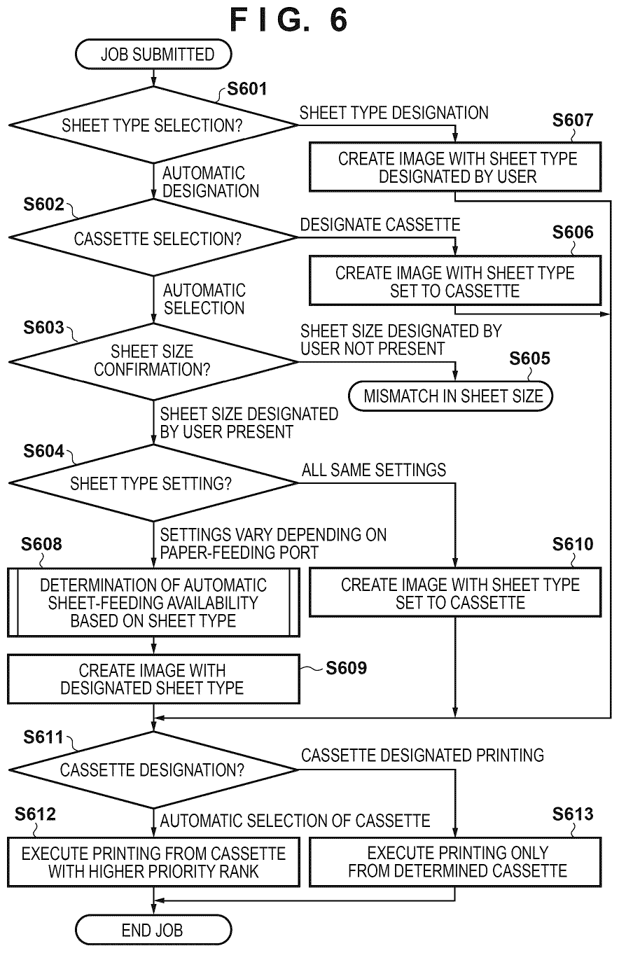

Note that, in FIG. 3, the processing for determining the presence/absence of a sheet in a sheet-feeding cassette is executed twice, namely in steps S303 and S305. However, as long as the number of times the determination processing is executed corresponds to the number of sheet-feeding cassettes to which the sheet size designated by the print job is set, the determination processing may be executed a number of times that is different from that in FIG. 3. Furthermore, the processing in steps S303 to S306 in FIG. 3 corresponds to that in step S612 in FIG. 6; this will be described later.

Subsequently, an example in which image generation processing and print control processing are executed in parallel will be described chronologically with reference to FIG. 4.

FIG. 4 illustrates a chronological flow relating to image generation processing and print control processing, and the horizontal axis indicates the lapse of time. In the present example, the lapse of time represents the elapsed time from when a job is submitted, expressed in seconds. The elapsed time is one example, and may change depending on sheet size and image content. In the present example, an example is illustrated in which data for three pages is printed based on one print job.

Image generation processing 402 by the controller unit 100 indicates that it takes one second to generate an image of the first page in step S302 from when the print job is submitted. Print control processing 403 by the print engine unit 200 indicates that it takes two seconds to print the image of the first page in step S304 or S306. In order to print an image, the generation of the image needs to be complete, and, as illustrated in FIG. 4, it takes two seconds from the completion of image generation processing 402 to the completion of print control processing 403.

Image generation processing 404 by the controller unit 100 indicates that it takes one second to generate an image of the second page in step S302.

In the present embodiment, image generation processing and print control processing can be executed in parallel because the controller unit 100 and the print engine unit 200 are units different from one another. Thus, once image generation processing 402 for the image of the first page is complete, image generation processing 404 for an image of the second page can be started in parallel with print control processing 403 for the image of the first page.

Print control processing 405 by the print engine unit 200 indicates that it takes two seconds to print the image of the second page in step S304 or S306. Image generation processing 404 for the second page is completed after two seconds from the submission of the print job. However, because the printing of the image of the first page is not complete, print control processing 405 for the image of the second page is started once print control processing 403 by the print engine unit 200 is completed.

Image generation processing 406 by the controller unit 100 indicates that it takes one second to generate an image of the third page in step S302. Similarly to image generation processing 404, image generation processing 406 can be started once image generation processing 404 is complete. Furthermore, image generation processing and print control processing can be executed in parallel because the controller unit 100 and the print engine unit 200 are units different from one another. Thus, once image generation processing 404 for the image of the second page is complete, image generation processing 406 for the image of the third page can be started in parallel with print control processing 403 for the image of the first page.

Print control processing 407 by the print engine unit 200 indicates that it takes two seconds to print the image of the third page in step S304 or S306. Image generation processing 406 for the third page is completed after three seconds from the submission of the print job. However, because the printing of the image of the second page is not complete, print control processing 407 for the image of the third page is started once print control processing 405 by the print engine unit 200 is completed.

By control as illustrated in FIG. 4, image generation processing and print control processing for three pages can be executed in seven seconds from the submission of the print job. If the controller unit 100 and the print engine unit 200 were not capable of executing processing in parallel, it would take 9 seconds for three pages because image generation processing and print control processing for each page would take three seconds.

In the present embodiment, the throughput in processing of a print job can be increased because, as described up to this point, a configuration is adopted in which image generation processing by the controller unit 100 and print control processing by the print engine unit 200 can be executed in parallel.

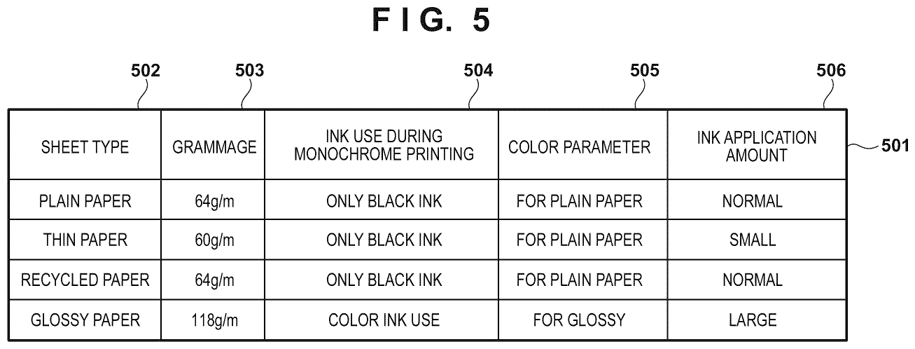

FIG. 5 is a diagram illustrating an example of setting parameters used to execute image generation processing based on sheet type information. A table 501 is a table indicating the correspondence between sheet types 502 and setting parameters 503 to 506 for different items.

The sheet types 502 indicate sheet types. In FIG. 5, four sheet types, namely plain paper, thin paper, recycled paper, and glossy paper, are illustrated as an example; however, other sheet types, such as thick paper and photo paper, may be present.

The setting parameter 503 indicates the grammage corresponding to the sheet type.

The setting parameter 504 indicates the ink(s) to be used during monochrome printing. In FIG. 5, it is assumed that inks of the four colors cyan, magenta, yellow, and black are used in the printing apparatus 1. For example, glossy paper is paper characterized by the glossiness thereof, and thus a glossy image needs to be printed even if monochrome printing is designated. Thus, based on the setting parameter 504, control is performed so that black is obtained by combining the color inks of cyan, magenta, and yellow, rather than using only black ink. On the other hand, for plain paper, thin paper, and recycled paper, control is performed so that only black ink is used and the color inks of cyan, magenta, and yellow are not used if monochrome printing is designated.

The setting parameter 505 indicates the color parameter to be used. The color parameter is a set of mixing values of the cyan, magenta, yellow, and black inks. FIG. 5 shows that a color parameter for plain paper and a color parameter for glossy paper can be set. A glossy image can be generated by using the color parameter for glossy paper. Note that in FIG. 5, while the color parameter for plain paper is set to plain paper, thin paper, and recycled paper, a configuration may be adopted such that the color parameter varies for each sheet type. For example, a color parameter for thin paper that is different from the color parameter for plain paper may be set.

The setting parameter 506 indicates ink droplet application amount. For example, the ink droplet application amount is the ink droplet application amount per pixel. Because thin paper has a low grammage, ink bleeding, etc., may occur with a large application amount. Thus, based on the setting parameter 506, control is performed so that the ink droplet application amount for thin paper is less than that for other sheet types. On the other hand, because glossy paper is paper having a coated surface, rub resistance may decrease with a small ink droplet application amount. Thus, based on the setting parameter 506, control is performed so that the ink droplet application amount for glossy paper is more than that for other sheet types. In FIG. 5, the ink application amount is expressed by “normal”, “small”, or “large”; however, the ink application amount may be expressed using other parameters, such as a dot count. Note that the setting parameters are not limited to the setting parameters 503 to 506 illustrated in FIG. 5, and other parameters may be set.

FIG. 6 is a flowchart illustrating processing for determining a sheet type and a sheet-feeding cassette. The processing in FIG. 6 includes the processing in FIG. 3. In the processing in FIG. 6, the main controller 101 refers to information about sheet type and sheet-feeding cassettes designated by the print job submitted to the printing apparatus 1. Furthermore, the main controller 101 determines a sheet type and a sheet-feeding cassette to be used to process the print job based on setting values of the sheet-feeding cassettes in the printing apparatus 1.

In step S601, based on the information about sheet type designated by the print job, the main controller 101 determines whether the designation of sheet type indicates user designation or automatic selection. The main controller 101 advances to step S602 if it is determined that automatic selection is indicated. On the other hand, the main controller 101 advances to step S607 if it is determined that user designation is indicated.

In step S607, the main controller 101 executes image generation processing based on the setting parameters of the sheet type designated by the user. For example, the setting parameters here are the setting parameters illustrated in FIG. 5. After step S607, in step S611, the main controller 101 determines whether or not to switch between sheet-feeding cassettes. In a case in which the main controller 101 has advanced to step S611 from step S607, the main controller 101 determines not to switch between sheet-feeding cassettes and advances to step S613 if the sheet type designated by the user is set to only one sheet-feeding cassette among the sheet-feeding cassettes corresponding to the sheet size designated by the print job. In step S613, the print engine unit 200 determines the one sheet-feeding cassette as the sheet-feeding cassette to be used for print control processing, executes print control processing, and ends the processing in FIG. 6. On the other hand, the main controller 101 determines to switch between sheet-feeding cassettes and advances to step S612 if the sheet type designated by the user is set to two or more of the sheet-feeding cassettes corresponding to the sheet size designated by the print job. In step S612, the print engine unit 200 determines the sheet-feeding cassette with the highest priority rank among the two or more sheet-feeding cassettes as the sheet-feeding cassette to be used for print control processing, executes print control processing, and ends the processing in FIG. 6. The processing in step S612 in this case corresponds to the processing from step S303 to step S307 in FIG. 3.

In step S602, based on the information about sheet-feeding cassettes designated by the print job, the main controller 101 determines whether the designation of sheet-feeding cassette indicates user designation or automatic selection. The main controller 101 advances to step S603 if it is determined that automatic selection is indicated. On the other hand, the main controller 101 advances to step S606 if it is determined that user designation is indicated.

In step S606, the main controller 101 executes image generation processing based on the setting parameters of the sheet type set to the sheet-feeding cassette designated by the user. For example, the setting parameters here are the setting parameters illustrated in FIG. 5. After step S606, in step S611, the main controller 101 determines whether or not to switch between sheet-feeding cassettes. In a case in which the main controller 101 has advanced to step S611 from step S606, the main controller 101 determines not to switch between sheet-feeding cassettes and advances to step S613 because a sheet-feeding cassette is designated by the user. In step S613, the print engine unit 200 determines the sheet-feeding cassette designated by the user as the sheet-feeding cassette to be used for print control processing, executes print control processing, and ends the processing in FIG. 6.

In step S603, the main controller 101 determines whether or not a sheet-feeding cassette to which the sheet size designated by the print job is set is present. If it is determined that no sheet-feeding cassette to which the sheet size designated by the print job is set is present, the main controller 101 executes error processing in step S605 and ends the processing in FIG. 6. For example, the error processing is processing for displaying, on the operation panel 104, a screen for providing a notification of a mismatch in sheet size. If it is determined that a sheet-feeding cassette to which the sheet size designated by the print job is set is present, the main controller 101 advances to step S604.

In step S604, the main controller 101 determines whether or not the same sheet type is set to all of the sheet-feeding cassettes to which the sheet size designated by the print job is set. For example, it is determined that the same sheet type is set if “sheet size: A4” and “sheet type: plain sheet” are set to all of sheet-feeding cassettes 2 to 5. Furthermore, in step S604, it is determined that the same sheet type is set also if there is only one sheet-feeding cassette to which the sheet size designated by the print job is set. If it is determined that the same sheet type is set, in step S610, the main controller 101 executes image generation processing based on the setting parameters of the sheet type. For example, the setting parameters here are the setting parameters illustrated in FIG. 5. After step S610, in step S611, the main controller 101 determines whether or not to switch between sheet-feeding cassettes. In a case in which the main controller 101 has advanced to step S611 from step S610, the main controller 101 determines not to switch between sheet-feeding cassettes and advances to step S613 if the sheet size designated by the print job is set to only one sheet-feeding cassette. In step S613, the print engine unit 200 determines the one sheet-feeding cassette as the sheet-feeding cassette to be used for print control processing, executes print control processing, and ends the processing in FIG. 6. On the other hand, if the sheet size designated by the print job is set to two or more sheet-feeding cassettes, the main controller 101 determines to switch between sheet-feeding cassettes and advances to step S612. In step S612, the print engine unit 200 determines the sheet-feeding cassette with the highest priority rank among the two or more sheet-feeding cassettes as the sheet-feeding cassette to be used for print control processing, executes print control processing, and ends the processing in FIG. 6. The processing in step S612 in this case corresponds to the processing from step S303 to step S307 in FIG. 3.

In step S608, the main controller 101 determines the sheet type for which image generation processing is to be executed.

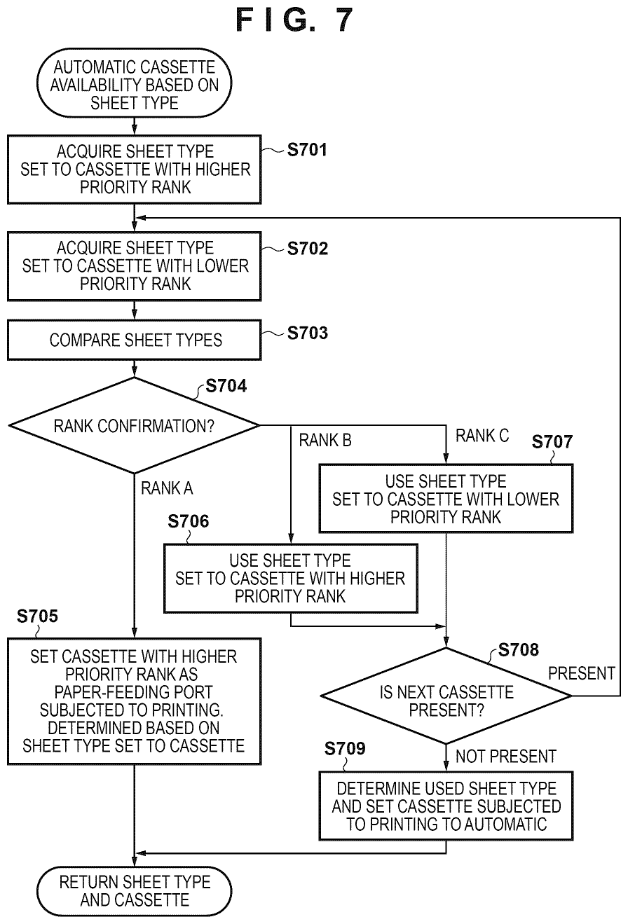

FIG. 7 is a flowchart illustrating the processing in step S608 of FIG. 6 for determining the sheet type for which image generation processing is to be executed. Here, the processing in FIG. 7 will be described based on a case in which the sheet-feeding cassettes are set as follows.
<Case A>
   Sheet-feeding cassette 2 sheet size: A4, sheet type: plain paper
   Sheet-feeding cassette 3 sheet size: A4, sheet type: thin paper
   Sheet-feeding cassette 4 sheet size: A4, sheet type: recycled paper
   Sheet-feeding cassette 5 sheet size: A4, sheet type: glossy paper

In step S701, the main controller 101 focuses on the sheet-feeding cassette with the highest priority rank in accordance with the priority ranks of the sheet-feeding cassettes, and acquires the sheet type set to the sheet-feeding cassette as a sheet type set to the sheet-feeding cassette with the highest priority rank. In case A, the main controller 101 acquires the sheet type “plain paper” set to sheet-feeding cassette 2 with the highest sheet-feeding cassette priority rank as information about the sheet type set to the sheet-feeding cassette with the higher priority rank.

In step S702, the main controller 101 focuses on the sheet-feeding cassette with the highest priority rank among the sheet-feeding cassettes that have not been focused on in the processing in FIG. 7, and acquires the sheet type set to the sheet-feeding cassette as a sheet type set to the sheet-feeding cassette with the lower priority rank. In case A, the main controller 101 acquires the sheet type “thin paper” set to sheet-feeding cassette 3 as information about the sheet type set to the sheet-feeding cassette with the lower priority rank.

In step S703, the main controller 101 compares the sheet type set to the sheet-feeding cassette with the higher priority rank and the sheet type set to the sheet-feeding cassette with the lower priority rank. In case A, the main controller 101 compares “plain paper” set to sheet-feeding cassette 2 and “thin paper” set to sheet-feeding cassette 3.

In step S704, the main controller 101 specifies a rank based on the result of the comparison in step S703.

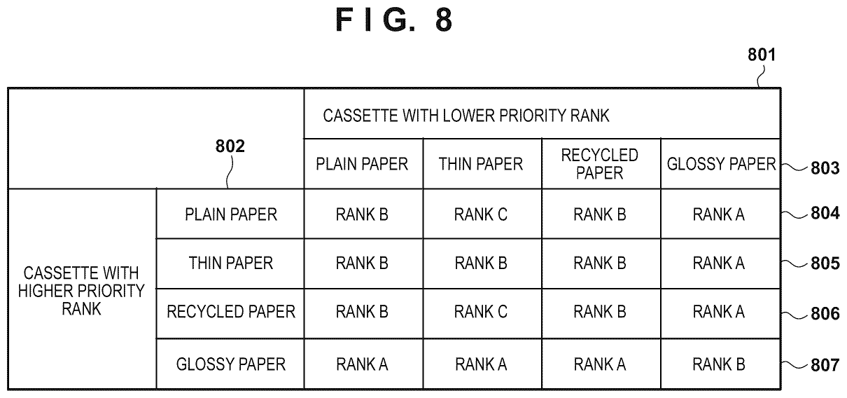

Here, ranks will be described with reference to FIG. 8.

FIG. 8 is a diagram illustrating an example of information for specifying ranks by comparing sheet types. While the information for specifying ranks is illustrated in the form of a table in FIG. 8, the information may be defined in a different form.

Table 801 illustrates ranks to be specified based on combinations of the sheet type set to the sheet-feeding cassette with the higher priority rank in step S701 and the sheet type set to the sheet-feeding cassette with the lower priority rank in step S702.

Sheet type 802 indicates sheet types that can be set to the sheet-feeding cassette with the higher priority rank. In FIG. 8, four sheet types, namely plain paper, thin paper, recycled paper, and glossy paper are set as an example; however, other sheet types may be set. Sheet type 803 indicates sheet types that can be set to the sheet-feeding cassette with the lower priority rank. In FIG. 8, four sheet types, namely plain paper, thin paper, recycled paper, and glossy paper are set as an example; however, other sheet types may be set.

Row 804 indicates ranks that can be specified in accordance with combinations with the sheet types in sheet type 803 in a case in which sheet type 802 is plain paper. For example, rank B is specified if sheet type 802 is plain paper and sheet type 803 is plain paper.

Row 805 indicates ranks that can be specified in accordance with combinations with the sheet types in sheet type 803 in a case in which sheet type 802 is thin paper.

Row 806 indicates ranks that can be specified in accordance with combinations with the sheet types in sheet type 803 in a case in which sheet type 802 is recycled paper.

Row 807 indicates ranks that can be specified in accordance with combinations with the sheet types in sheet type 803 in a case in which sheet type 802 is glossy paper.

Rank A shown in FIG. 8 indicates that there is a difference in setting parameter values between the sheet types, and that print quality would be affected to a great extent if the sheet type is changed from one to the other. This being the case, in the case of rank A, the sheet type set to the sheet-feeding cassette with the higher priority rank is determined as the sheet type to be used for image generation processing, and the sheet-feeding cassette is fixedly used as the sheet-feeding source. In other words, it can be said that rank A is a value indicating that the sheet type set to the sheet-feeding cassette with the higher priority rank is to be determined as the sheet type to be used for image generation processing, and that switching between sheet-feeding cassettes is disabled.

Rank B shown in FIG. 8 indicates that there is no significant difference in setting parameter values between the sheet types, and that the sheet type set to the sheet-feeding cassette with the higher priority rank is to be determined as the sheet type to be used for image generation processing. In other words, it can be said that rank B is a value indicating that the sheet type set to the sheet-feeding cassette with the higher priority rank is to be determined as the sheet type to be used for image generation processing, and that switching between sheet-feeding cassettes is enabled.

Rank C shown in FIG. 8 indicates that, while there is no significant difference in setting parameter values between the sheet types, the sheet type set to the sheet-feeding cassette with the lower priority rank is to be determined as the sheet type to be used for image generation processing from the perspective of print quality. In other words, it can be said that rank C is a value indicating that the sheet type set to the sheet-feeding cassette with the lower priority rank is to be determined as the sheet type to be used for image generation processing, and that switching between sheet-feeding cassettes is enabled.

In case A, in step S704, rank C is specified based on “plain paper” set to sheet-feeding cassette 2 with the higher priority rank and “thin paper” set to sheet-feeding cassette 3 with the lower priority rank.

The main controller 101 advances to step S707 if rank C is specified in step S704.

In step S707, the main controller 101 sets the sheet type set to the sheet-feeding cassette with the lower priority rank as the new “sheet type set to the sheet-feeding cassette with the higher priority rank”. In case A, the main controller 101 sets the sheet type “thin paper” set to sheet-feeding cassette 3 as the new “sheet type set to the sheet-feeding cassette with the higher priority rank”.

After step S707, in step S708, the main controller 101, in accordance with the priority ranks, determines whether or not a sheet-feeding cassette that has not been focused on is present. In case A, because sheet-feeding cassettes 4 and 5 have not been focused on yet, it is determined that a sheet-feeding cassette that has not been focused on yet is present, and the main controller 101 advances to step S702.

In step S702, the main controller 101 focuses on the sheet-feeding cassette with the highest priority rank among the sheet-feeding cassettes that have not been focused on in the processing in FIG. 7, and acquires the sheet type set to the sheet-feeding cassette as the new “sheet type set to the sheet-feeding cassette with the lower priority rank”. In case A, the main controller 101 acquires the sheet type “recycled paper” set to sheet-feeding cassette 4 with the higher priority rank among sheet-feeding cassettes 4 and 5, which have not been focused on yet, as the new “sheet type set to the sheet-feeding cassette with the lower priority rank”.

In step S703, the main controller 101 compares the sheet type set to the sheet-feeding cassette with the higher priority rank and the sheet type set to the sheet-feeding cassette with the lower priority rank. In case A, the main controller 101 compares “thin paper” set to sheet-feeding cassette 3 and “recycled paper” set to sheet-feeding cassette 4.

In step S704, the main controller 101 specifies a rank based on the result of the comparison in step S703.

In case A, in step S704, rank B is specified based on “thin paper” set to sheet-feeding cassette 3 with the higher priority rank and “recycled paper” set to sheet-feeding cassette 4 with the lower priority rank.

The main controller 101 advances to step S706 if rank B is specified in step S704.

In step S706, the main controller 101 sets the sheet type set to the sheet-feeding cassette with the higher priority rank as the new “sheet type set to the sheet-feeding cassette with the higher priority rank”. In case A, the main controller 101 sets the sheet type “thin paper” set to sheet-feeding cassette 3 as the new “sheet type set to the sheet-feeding cassette with the higher priority rank”.

After step S706, in step S708, the main controller 101, in accordance with the priority ranks, determines whether or not a sheet-feeding cassette that has not been focused on is present. In case A, because sheet-feeding cassette 5 has not been focused on yet, it is determined that a sheet-feeding cassette that has not been focused on yet is present, and the main controller 101 advances to step S702.

In step S702, the main controller 101 focuses on the sheet-feeding cassette with the highest priority rank among the sheet-feeding cassettes that have not been focused on in the processing in FIG. 7, and acquires the sheet type set to the sheet-feeding cassette as the new “sheet type set to the sheet-feeding cassette with the lower priority rank”. In case A, the main controller 101 acquires the sheet type “glossy paper” set to sheet-feeding cassette 5, which has not been focused on yet, as the new “sheet type set to the sheet-feeding cassette with the lower priority rank”.

In step S703, the main controller 101 compares the sheet type set to the sheet-feeding cassette with the higher priority rank and the sheet type set to the sheet-feeding cassette with the lower priority rank. In case A, the main controller 101 compares “thin paper” set to sheet-feeding cassette 3 and “glossy paper” set to sheet-feeding cassette 5.

In step S704, the main controller 101 specifies a rank based on the result of the comparison in step S703.

In case A, in step S704, rank A is specified based on “thin paper” set to sheet-feeding cassette 3 with the higher priority rank and “glossy paper” set to sheet-feeding cassette 5 with the lower priority rank.

The main controller 101 advances to step S705 if rank A is specified in step S704.

In step S705, the main controller 101 determines, as the sheet type to be used for image generation processing, the sheet type set to the sheet-feeding cassette with the higher priority rank. In case A, the main controller 101 determines “thin paper” set to sheet-feeding cassette 3 as the sheet type to be used for image generation processing. In step S705, the main controller 101 stores information about the sheet type to be used for image generation processing and information about sheet-feeding cassettes to a storage area of the RAM 106 or the like, and ends the processing in FIG. 7. In case A, “thin paper” is stored as the information about the sheet type to be used for image generation processing, and “sheet-feeding cassette 3” is stored as the information about sheet-feeding cassettes.

The description of the processing in FIG. 6 will be continued with reference to case A.

In step S609, the main controller 101 executes image generation processing based on the setting parameters of the sheet type determined in step S608. For example, the setting parameters here are the setting parameters illustrated in FIG. 5. After step S609, in step S611, the main controller 101 determines whether or not to switch between sheet-feeding cassettes. If the main controller 101 has advanced to step S611 from step S609, the main controller 101 determines not to switch between sheet-feeding cassettes and advances to step S613 if the sheet type has been determined in step S705. In step S613, the print engine unit 200 determines the sheet-feeding cassette as the sheet-feeding cassette to be used for print control processing, executes print control processing, and ends the processing in FIG. 6. In case A, image generation processing is executed in step S609 based on the setting parameters of “thin paper” set to sheet-feeding cassette 3, and it is determined in step S611 that switching between sheet-feeding cassettes from sheet-feeding cassette 3 is not to be performed. Subsequently, the print engine unit 200 ends the processing in FIG. 6.

In case A, as a result of the processing in FIG. 7, the main controller 101 acquires the sheet type “thin paper” set to sheet-feeding cassette 3 in step S301 in FIG. 3. Then, in step S302, the main controller 101 executes image generation processing for the number of pages included in the print job based on the setting parameters of the sheet type “thin paper”. In case A, the processing from step S303 to step S307 is not executed because the processing in step S613 is executed and thus switching between sheet-feeding cassettes from sheet-feeding cassette 3 is not performed. In case A, if the sheets in sheet-feeding cassette 3 are exhausted, the main controller 101 determines that a sheet-out error has occurred and executes error processing.

As described up to this point, in case A, a sheet type to be used for image generation processing is temporarily and provisionally determined in steps S706 and S707. The provisionally determined sheet type is the sheet type that is regarded as being most suitable among the sheet types set to the sheet-feeding cassettes that have been focused on up to the point, and is a sheet type for which it is regarded that, even if switching between sheet-feeding cassettes is performed, print quality would not be significantly affected thereby. Furthermore, if rank A is subsequently determined in step S704, the impact that the switching between sheet-feeding cassettes has on print quality increases; thus, it is determined that the sheet-feeding cassette to which the sheet type that has been regarded as being most suitable up to the point is to be fixedly used as the sheet-feeding source, and the sheet type is determined as the sheet type to be used for image generation processing. Thus, prior to print control processing, image generation processing for the number of pages included in the print job can be executed based on a sheet type for which print quality would not be affected much even if switching between sheet-feeding cassettes is performed. Consequently, the risk of the print quality differing from what is intended by the user can be reduced, and the throughput of processing of the print job can be improved.

In regard to case A, description has been provided that, once rank A is determined in step S704, the sheet-feeding cassette to which the sheet type that has been regarded as being most suitable up to the point is set is fixedly used as the sheet-feeding source. However, a configuration may be adopted such that switching between sheet-feeding cassettes is performed among sheet-feeding cassettes that have been focused on up to the point.

Next, the processing in FIG. 7 will be described based on case B.
<Case B>
   Sheet-feeding cassette 2 sheet size: A4, sheet type: plain paper
   Sheet-feeding cassette 3 sheet size: A4, sheet type: thin paper

In step S701, the main controller 101 focuses on the sheet-feeding cassette with the highest priority rank in accordance with the priority ranks of the sheet-feeding cassettes, and acquires the sheet type set to the sheet-feeding cassette as a sheet type set to the sheet-feeding cassette with the highest priority rank. In case B, the main controller 101 acquires the sheet type “plain paper” set to sheet-feeding cassette 2 with the highest sheet-feeding cassette priority rank as information about the sheet type set to the sheet-feeding cassette with the higher priority rank.

In step S702, the main controller 101 focuses on the sheet-feeding cassette with the highest priority rank among the sheet-feeding cassettes that have not been focused on in the processing in FIG. 7, and acquires the sheet type set to the sheet-feeding cassette as a sheet type set to the sheet-feeding cassette with the lower priority rank. In case B, the main controller 101 acquires the sheet type “thin paper” set to sheet-feeding cassette 3 as information about the sheet type set to the sheet-feeding cassette with the lower priority rank.

In step S703, the main controller 101 compares the sheet type set to the sheet-feeding cassette with the higher priority rank and the sheet type set to the sheet-feeding cassette with the lower priority rank. In case B, the main controller 101 compares “plain paper” set to sheet-feeding cassette 2 and “thin paper” set to sheet-feeding cassette 3.

In step S704, the main controller 101 specifies a rank based on the result of the comparison in step S703.

In case B, in step S704, rank C is specified based on “plain paper” set to sheet-feeding cassette 2 with the higher priority rank and “thin paper” set to sheet-feeding cassette 3 with the lower priority rank.

The main controller 101 advances to step S707 if rank C is specified in step S704.

In step S707, the main controller 101 sets the sheet type set to the sheet-feeding cassette with the lower priority rank as the new “sheet type set to the sheet-feeding cassette with the higher priority rank”. In case B, the main controller 101 sets the sheet type “thin paper” set to sheet-feeding cassette 3 as the new “sheet type set to the sheet-feeding cassette with the higher priority rank”.

After step S707, in step S708, the main controller 101, in accordance with the priority ranks, determines whether or not a sheet-feeding cassette that has not been focused on is present. In case B, because there is no sheet-feeding cassette that has not been focused on yet, it is determined that a sheet-feeding cassette that has not been focused on yet is not present, and the main controller 101 advances to step S709.

In step S709, the main controller 101 determines, as the sheet type to be used for image generation processing, the sheet type set to the sheet-feeding cassette with the higher priority rank. In case B, the main controller 101 determines “thin sheet” set to sheet-feeding cassette 3 as the sheet type to be used for image generation processing. In step S709, the main controller 101 stores information about the sheet type to be used for image generation processing and information about sheet-feeding cassettes to a storage area of the RAM 106 or the like, and ends the processing in FIG. 7. In case B, “thin paper” is stored as the information about the sheet type to be used for image generation processing, and “automatic selection” is stored as the information about sheet-feeding cassettes.

The description of the processing in FIG. 6 will be continued with reference to case B.

In step S609, the main controller 101 executes image generation processing based on the setting parameters of the sheet type determined in step S608. For example, the setting parameters here are the setting parameters illustrated in FIG. 5. After step S609, in step S611, the main controller 101 determines whether or not to switch between sheet-feeding cassettes. If the main controller 101 has advanced to step S611 from step S609, the main controller 101 determines to switch between sheet-feeding cassettes and advances to step S612 if the sheet type has been determined in step S709. In step S612, the print engine unit 200 determines the sheet-feeding cassette with the highest priority rank as the sheet-feeding cassette to be used for print control processing, executes print control processing, and ends the processing in FIG. 6.

In case B, as a result of the processing in FIG. 7, the main controller 101 acquires the sheet type “thin paper” set to sheet-feeding cassette 3 in step S301 in FIG. 3. Then, in step S302, the main controller 101 executes image generation processing for the number of pages included in the print job based on the setting parameters of the sheet type “thin paper”. In case B, the processing from step S303 to step S307 is executed because the processing in step S612 is executed. That is, in case B, if sheets in sheet-feeding cassette 2 are exhausted, the main controller 101 advances from step S303 to step S305 to determine whether or not a sheet is present in sheet-feeding cassette 3. If it is determined that a sheet is present in sheet-feeding cassette 3, print control processing is executed using a sheet in sheet-feeding cassette 3 in step S306. That is, switching between sheet-feeding cassettes is performed. In case B, if it is determined that a sheet is present in sheet-feeding cassette 2 in step S303, print control processing is executed using a sheet in sheet-feeding cassette 2. While the sheet type set to sheet-feeding cassette 2 is “plain paper”, image generation processing has been executed based on the setting parameters of “thin paper”. However, because there is no significant difference in setting parameter values between the two sheet types, the risk of the print quality differing from what is intended by the user can be reduced. Furthermore, as is the case with case A, the throughput of processing of the print job can be improved.

In the present embodiment, by using table 801 illustrated in FIG. 8, the sheet type for which image generation processing is to be executed is determined automatically without the intervention of user operations. However, a configuration may be adopted such that a rank corresponding to a combination of sheet types can be set via the operation panel 104. Furthermore, a rank may be specified based on a designation made in the print job. For example, a configuration may be adopted such that, if monochrome printing is designated in the print job, a rank that is different from the content of table 801 in FIG. 8 is specified.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-033161, filed Mar. 3, 2025 which is hereby incorporated by reference herein in its entirety.

What is claimed is:

1. A printing apparatus comprising at least one memory and at least one processor which function as:
an image generation unit configured to, in a case in which a first sheet type set for first sheet-feeding unit and a second sheet type set for a second sheet-feeding unit that houses sheets of a same size as sheets housed in the first sheet-feeding unit are different from one another, determine whether image generation corresponding to the first sheet type or image generation corresponding to the second sheet type is to be performed, based on a combination of the first sheet type and the second sheet type, and perform the image generation corresponding to the determined sheet type; and
a print control unit configured to, after the image generation is performed by the image generation unit, execute printing using the first sheet-feeding unit as a sheet-feeding source, and, based on the combination, control whether or not the sheet-feeding source is to be switched from the first sheet-feeding unit to the second sheet-feeding unit when the sheets in the first sheet-feeding unit are exhausted.

2. The printing apparatus according to claim 1,
wherein, if it is determined that the image generation corresponding to the first sheet type is to be performed, the image generation unit executes the image generation based on a first parameter for the image generation corresponding to the first sheet type, and
if it is determined that the image generation corresponding to the second sheet type is to be performed, the image generation unit executes the image generation based on a second parameter for the image generation corresponding to the second sheet type.

3. The printing apparatus according to claim 2,
wherein the combination is associated with one of a plurality of ranks based on a difference between the first parameter and the second parameter.

4. The printing apparatus according to claim 3,
wherein the first parameter and the second parameter include at least one of:
information relating to ink to be used during monochrome printing; information relating to ink mixing; and information relating to an ink application amount.

5. The printing apparatus according to claim 4,
wherein the plurality of ranks include:
a first rank indicating that switching from the first sheet-feeding unit to the second sheet-feeding unit is enabled, and the image generation corresponding to the first sheet type is to be performed;
a second rank indicating that switching from the first sheet-feeding unit to the second sheet-feeding unit is enabled, and the image generation corresponding to the second sheet type is to be performed; and
a third rank indicating that switching from the first sheet-feeding unit to the second sheet-feeding unit is disabled, and the image generation corresponding to the first sheet type is to be performed.

6. The printing apparatus according to claim 5,
wherein, if the rank associated with the combination is the first rank,
the image generation unit determines that the image generation corresponding to the first sheet type is to be performed, and
the print control unit performs control so as to switch the sheet-feeding source from the first sheet-feeding unit to the second sheet-feeding unit when the sheets in the first sheet-feeding unit are exhausted.

7. The printing apparatus according to claim 5,
wherein, if the rank associated with the combination is the second rank,
the image generation unit determines that the image generation corresponding to the second sheet type is to be performed, and
the print control unit performs control so as to switch the sheet-feeding source from the first sheet-feeding unit to the second sheet-feeding unit when the sheets in the first sheet-feeding unit are exhausted.

8. The printing apparatus according to claim 5,
wherein, if the rank associated with the combination is the third rank,
the image generation unit determines that the image generation corresponding to the first sheet type is to be performed, and
the print control unit performs control so as not to switch the sheet-feeding source from the first sheet-feeding unit to the second sheet-feeding unit when the sheets in the first sheet-feeding unit are exhausted.

9. The printing apparatus according to claim 3 further comprising
a storage unit configured to store the rank associated with the combination.

10. The printing apparatus according to claim 1,
wherein the image generation unit determines whether image generation corresponding to the first sheet type or image generation corresponding to the second sheet type is to be performed, based on an instruction from a user and the combination of the first sheet type and the second sheet type.

11. The printing apparatus according to claim 1,
wherein, when a print job is processed, the image generation by the image generation unit and the control by the print control unit are executed.

12. The printing apparatus according to claim 11,
wherein the image generation by the image generation unit and the control by the print control unit are executed if automatic selection of a sheet-feeding unit is designated by the print job.

13. The printing apparatus according to claim 12,
wherein the image generation by the image generation unit and the control by the print control unit are executed if automatic selection of a sheet type is designated by the print job.

14. The printing apparatus according to claim 11,
wherein the print job is a job involving a plurality of pages including a first page and a second page,
the print control unit starts the printing of the first page after the image generation of the first page is performed by the image generation unit, and
the image generation of the second page by the image generation unit is executed in parallel with the printing of the first page by the print control unit.

15. The printing apparatus according to claim 1,
wherein the switching from the first sheet-feeding unit to the second sheet-feeding unit is performed based on a predetermined order established between the first sheet-feeding unit and the second sheet-feeding unit.

16. The printing apparatus according to claim 1,
wherein the first sheet-feeding unit and the second sheet-feeding unit are sheet-feeding cassettes.

17. A method to be executed in a printing apparatus, said method comprising:
in a case in which a first sheet type set for a first sheet-feeding unit and a second sheet type set for a second sheet-feeding unit that houses sheets of a same size as sheets housed in the first sheet-feeding unit are different from one another, determining whether image generation corresponding to the first sheet type or image generation corresponding to the second sheet type is to be performed, based on a combination of the first sheet type and the second sheet type, and performing the image generation corresponding to the determined sheet type; and
after the image generation is performed, executing printing using the first sheet-feeding unit as a sheet-feeding source, and, based on the combination, controlling whether or not the sheet-feeding source is to be switched from the first sheet-feeding unit to the second sheet-feeding unit when the sheets in the first sheet-feeding unit are exhausted.

18. A non-transitory computer-readable storage medium storing a program configured to cause a computer of an information processing apparatus to function to:
in a case in which a first sheet type set for a first sheet-feeding unit and a second sheet type set for a second sheet-feeding unit that houses sheets of a same size as sheets housed in the first sheet-feeding unit are different from one another, determine whether image generation corresponding to the first sheet type or image generation corresponding to the second sheet type is to be performed, based on a combination of the first sheet type and the second sheet type, and perform the image generation corresponding to the determined sheet type; and
after the image generation is performed, execute printing using the first sheet-feeding unit as a sheet-feeding source, and, based on the combination, control whether or not the sheet-feeding source is to be switched from the first sheet-feeding unit to the second sheet-feeding unit when the sheets in the first sheet-feeding unit are exhausted.
